(19) United States
(12) Patent Application Publication
(10) Pub. No.: US 2026/0061658 A1
(43) Pub. Date: Mar. 5, 2026

(54) BAMBOO WITH SINGLE-SIDED DENSIFICATION ON BAMBOO INNER LAYER, AND PREPARATION METHOD AND USE THEREOF

(71) Applicant: International Centre for Bamboo and Rattan, Beijing (CN)

(72) Inventors: Xiaobei JIN, Beijing (CN); Rong ZHANG, Beijing (CN); Daochun QIN, Beijing (CN); Ying HE, Beijing (CN); Changhua FANG, Beijing (CN); Zixuan YU, Beijing (CN); Zehui JIANG, Beijing (CN)

(21) Appl. No.: 18/953,218

(22) Filed: Nov. 20, 2024

(30) Foreign Application Priority Data
Sep. 3, 2024 (CN) 202411230536.2

(51) Int. Cl. B27K 9/00

(52) U.S. Cl. CPC B27K 9/002; B27K 2200/30; B27K 2240/30

(57) ABSTRACT

Disclosed are a bamboo with single-sided densification on a bamboo inner layer, and a preparation method and use thereof. The method includes: placing the bamboo inner layer of the bamboo in an impregnation solution, and conducting an impregnation treatment to obtain an impregnated bamboo, wherein the impregnation solution includes water or a flame retardant solution; subjecting a resulting bamboo inner layer of the impregnated bamboo to a preheating and softening treatment to obtain a preheated and softened bamboo; maintaining a temperature for the preheating and softening treatment, while subjecting the preheated and softened bamboo to pressurization and compression to densify the bamboo to a target thickness, to obtain a compressed bamboo; and simultaneously subjecting a resulting bamboo inner layer and a bamboo outer layer of the compressed bamboo to a hot pressing and shaping treatment, and subjecting a resulting bamboo to cooling and depressurizing in sequence.

### CROSS REFERENCE TO RELATED APPLICATION

This patent application claims the benefit and priority of Chinese Patent Application No. 202411230536.2 filed with the China National Intellectual Property Administration on Sep. 3, 2024, and entitled with “BAMBOO WITH SINGLE-SIDED DENSIFICATION ON BAMBOO INNER LAYER, AND PREPARATION METHOD AND USE THEREOF”, the disclosure of which is incorporated by reference herein in its entirety as part of the present application.

### TECHNICAL FIELD

The present disclosure relates to the technical field of processing and modifying bamboo, and in particular to a bamboo with single-sided densification on a bamboo inner layer, and a preparation method and use thereof.

### BACKGROUND

In China, bamboo resources are extremely abundant, and bamboo has advantages such as rapid growth rate, wide distribution range, and high mechanical strength. Bamboo is a natural heterogeneous anisotropic material, which is divided horizontally into bamboo outer layer, bamboo middle layer, and bamboo inner layer from outside to inside of the bamboo culm wall. At the same time, bamboo has the weakness of thin wall, hollow and uneven structure, and these characteristics make it difficult to process bamboo. In the process of preparing bamboo boards, such as bamboo laminated lumber, bamboo scrimber, and bamboo particleboard, bamboo are processed into small units with rectangular cross-sections or bamboo fiber bundles, and then glued and pressed into boards. The utilization rate of raw materials is low, and a lot of chemical adhesives are needed, which affects the environmental protection of bamboo-based materials. The utilization rate and production efficiency of the bamboo can be significantly improved by using the flattened bamboo technology, which is conducted by softening, flattening, and shaping the arc-shaped bamboo splits. However, as an important way to utilize bamboo in its original state, flattened bamboo inherits the natural texture and density difference characteristics of the bamboo. The strength of the flattened bamboo is high but uneven, the inner part of the bamboo accounts for a relatively large proportion, and the basic density and surface hardness of the bamboo are relatively low. Due to the asymmetry of the density gradient structure of the flattened bamboo, it has a high tendency to bend and warp. In addition, flattened bamboo has disadvantages such as susceptible to water absorption, dry shrinkage and wet swelling, low dimensional stability and poor flame retardancy, which makes it difficult to meet the use requirements of high-performance materials.

Compression densification technology is an environmentally friendly and effective method to improve the structure and strength of lignocellulosic materials, and it is widely used in modifying and strengthening low-density wood (see CN116533340A, CN103753664A, CN107263657A, CN109623999A). In addition, CN114770681A reports a method for mechanically densifying a bamboo by delignification, which can effectively reduce the heterogeneity of the bamboo and improve its properties, but it requires a lot of chemical agents for delignification and chemical crosslinking agents for modification, which increases the environmental pressure, processing time and production cost. CN106881755A reports a method for densifying a wood/bamboo by hot pressing combined with the steam jet evaporation method, and the overall densification of the bamboo can be realized by hot pressing combined with the steam jet evaporation method. However, this method has high equipment requirements, and needs to be equipped with a press plate with steam jet holes, which is difficult to operate and consumes more energy. Literature [Construction and Building Materials, 2023, 392: 132073] reports a method of overall compression and densification of a flattened bamboo, in which natural bamboo chips with a moisture content of 70% are compressed along a radial direction of bamboo stem wall at a temperature of 170° C. to 190° C. to obtain a flattened bamboo with a relatively uniform density. However, with this method, the performance improvement effect of the compressed flattened bamboo depends on the larger overall compression ratio (about 44%) and the higher heating temperature of the upper and lower platens, which makes the compression layer be not controllable. Moreover, the method shows high energy consumption and large volume loss rate of the flattened bamboo, which increases the production cost.

### SUMMARY

In order to solve the problem in the existing technology, the present disclosure provides a bamboo with single-sided densification on a bamboo inner layer, and a preparation method and use thereof.

The bamboo with single-sided densification on the bamboo inner layer prepared by the method of the present disclosure can realize the control of the thickness and density of the compressed layer, and can significantly save energy consumption and reduce production costs by only heating a single-sided hot pressing plate.

In order to achieve the above object, the present disclosure provides the following technical solutions:

The present disclosure provides a method for preparing a bamboo with single-sided densification on a bamboo inner layer, including:
placing the bamboo inner layer of the bamboo in an impregnation solution, and conducting an impregnation treatment to obtain an impregnated bamboo; wherein the impregnation solution comprises one selected from the group consisting of water and a flame retardant solution;
subjecting a resulting bamboo inner layer of the impregnated bamboo to a preheating and softening treatment to obtain a preheated and softened bamboo;
maintaining a temperature for the preheating and softening treatment of the resulting bamboo inner layer, while subjecting the preheated and softened bamboo to pressurization and compression to densify the bamboo to a target thickness, to obtain a compressed bamboo; and
simultaneously subjecting a resulting bamboo inner layer and a bamboo outer layer of the compressed bamboo to a hot pressing and shaping treatment, and subjecting a resulting bamboo to cooling and depressurizing in sequence to obtain the bamboo with single-sided densification on the bamboo inner layer.

In some embodiments, the preheating and softening treatment is conducted by placing the impregnated bamboo in a hot press with a lower press plate not heated and an upper press plate preheated to a temperature of 120° C. to 180° C., and subjecting the impregnated bamboo to the preheating and softening treatment while applying a small pressure of 0.05 MPa to 0.1 MPa; during the preheating and softening treatment, the resulting bamboo inner layer of the impregnated bamboo is in contact with the upper press plate, and a bamboo outer layer of the impregnated bamboo is in contact with the lower press plate; and the preheating and softening treatment is conducted for 5 seconds(s) to 120 seconds(s); and
during the impregnation treatment, a depth of the impregnation is 10-50% of a total thickness of the bamboo; and the impregnation is conducted for 0.5 h to 4 h.

In some embodiments, the bamboo has a thickness of 6 mm to 15 mm; the bamboo includes one selected from the group consisting of Phyllostachys edulis, Dendrocalamus sinicus, Dendrocalamus latiflorus, Bambusa sinospinosa, and Bambusa pervariabilis; and
the bamboo includes one selected from the group consisting of a nicked flattened bamboo, a non-nicked flattened bamboo, and a rectangular bamboo strip.

In some embodiments, the flame retardant solution includes diammonium hydrogen phosphate, boric acid, borax, glucose, and water;
a mass ratio of the diammonium hydrogen phosphate, the boric acid, and the borax is in a range of (2-8):(1-5):(1-5);
a molar ratio of the diammonium hydrogen phosphate to the glucose is 1:1; and
the flame retardant solution has a mass concentration of 5-30%.

In some embodiments, after the impregnation treatment, a moisture content of the resulting bamboo inner layer of the impregnated bamboo is greater than 15%, and a moisture content of a bamboo outer layer of the impregnated bamboo is in a range of 5-12%.

In some embodiments, the pressurization and compression is conducted in a hot press;
the pressurization and compression is conducted at a pressure of 2 MPa to 40 MPa;
the pressurization and compression is conducted by progressive pressurization; the progressive pressurization is conducted by subjecting the preheated and softened bamboo to pressurization and compression for 1 to 5 cycles, each compression cycle comprises loading for 1 s to 3 s, and holding the loading for 5 s to 20 s, with a loading speed of 0.1 mm/s to 2.0 mm/s; and
during the pressurization and compression, a thickness of the compressed bamboo is controlled by a metal stopping stick between hot press plates, and the compressed bamboo has a compression ratio of 10 to 50%.

In some embodiments, the hot pressing and shaping treatment is conducted in a hot press;
the resulting bamboo inner layer of the compressed bamboo is heated to a temperature of 120° C. to 180° C.;
the bamboo outer layer of the compressed bamboo is heated to a temperature of 130° C. to 180° C.;
the hot pressing and shaping treatment is conducted at a pressure of 2 MPa to 40 MPa; and
the hot pressing and shaping treatment is conducted under heat preservation and pressure maintenance for 0.5 h to 6 h.

In some embodiments, the cooling and depressurizing is conducted by cooling an upper press plate and a lower press plate of the hot press to a temperature of 30° C. to 50° C. by passing cold water, and then depressurizing.

The present disclosure further provides a bamboo with single-sided densification on the bamboo inner layer prepared by the method described in the above technical solutions, including a compressed layer on the bamboo inner layer, an uncompressed layer on a core, and an uncompressed layer on a bamboo outer layer that are arranged sequentially in a thickness direction;
where the compressed layer on the bamboo inner layer has a peak density of 0.8 g/cm³ to 1.5 g/cm³, and the uncompressed layer on the bamboo outer layer has a peak density of 0.8 g/cm³ to 1.2 g/cm³.

The present disclosure further provides use of the bamboo with single-sided densification on the bamboo inner layer described in the above technical solutions in furniture, flooring, cutting boards and building, or interior decoration.

The present disclosure provides a method for preparing a bamboo with single-sided densification on a bamboo inner layer, including the following steps: placing the bamboo inner layer of the bamboo in an impregnation solution, and conducting an impregnation treatment to obtain an impregnated bamboo; wherein the impregnation solution comprises one selected from the group consisting of water and a flame retardant solution; subjecting a resulting bamboo inner layer of the impregnated bamboo to a preheating and softening treatment to obtain a preheated and softened bamboo; maintaining a temperature for the preheating and softening treatment of the resulting bamboo inner layer, while subjecting the preheated and softened bamboo to pressurization and compression to densify the bamboo to a target thickness, to obtain a compressed bamboo; and simultaneously subjecting a resulting bamboo inner layer and a bamboo outer layer of the compressed bamboo to a hot pressing and shaping treatment, and subjecting a resulting bamboo to cooling and depressurizing in sequence to obtain the bamboo with single-sided densification on the bamboo inner layer.

Compared with the prior art, the technology of the bamboo with single-sided densification on the bamboo inner layer provided by the present disclosure has the following unique technical points: 1. Water is used as a softening agent for the softening treatment of the bamboo inner layer, which is simpler, easier to operate and more energy efficient than high temperature softening methods such as steam, boiling water, and microwaves; and a flame retardant solution is used for the softening treatment of the bamboo inner layer, which can realize the all-in-one treatment of the compression and flame retardant process of the bamboo inner layer. 2. During the compression densification process of the bamboo, the directed impregnated bamboo inner layer is increased in plasticity under heat, and softened gradually with increasing preheating time at low compression rates, and then during the hot pressing and shaping treatment, the fixation of compression deformation of a resulting bamboo can be realized. The control of the thickness and density of the compressed layer can be realized by adjusting the parameters of the preheating and softening treatment, pressurization and compression, and hot pressing and shaping treatment. 3. During the preheating and softening treatment, only the bamboo inner layer is heated, which could significantly save energy and reduce production costs.

The results of the examples show that the single-sided densification on the bamboo inner layer significantly improves the overall performance of the bamboo. The bamboo with single-sided densification on the bamboo inner layer has a peak density of the compressed layer of reach up to 1.23 g/cm³, a surface hardness of the bamboo inner layer of 21.6 N/mm² to 26.8 N/mm², a flexural strength of 248.1 MPa to 279.0 MPa, and an elastic modulus of 11.5 GPa to 13.6 GPa. The peak density, surface hardness, flexural strength, and elastic modulus of the compressed layer on the bamboo inner layer of the bamboo with single-sided densification are greatly improved compared with the control material. In the present disclosure, the controllable compression densification of the bamboo inner layer of the bamboo can be realized by adjusting the parameters of the preheating and softening treatment, pressurization and compression, and hot pressing and shaping treatment, which makes the process environmentally friendly. When ensuring the natural high density of the bamboo outer layer, the peak density of the bamboo inner layer is increased to the same or higher level than that of the bamboo outer layer, while maintaining a certain thickness of the uncompressed layer on the core, forming a structure with symmetrical density distribution. In the present disclosure, the processing method could not only effectively reduce the volume loss rate of densified bamboo, and maintain the natural texture of the bamboo, but also increase the density and strength of the bamboo by increasing the compression ratio as needed, which makes the bamboo can be widely used in furniture, flooring, cutting boards and building, and interior decoration, and further enables the preparation of high-performance bamboo laminated lumber and bamboo-wood composite by gluing, thus promoting the green and healthy development of the bamboo industry.

### BRIEF DESCRIPTION OF THE DRAWINGS

FIG. 1A to FIG. 1B show cross-sectional views of the objects of the samples in Comparative Example 1 and Example 1.

FIG. 2A to FIG. 2B show scanning electron microscope (SEM) images of the cross-sectional view of the bamboo inner layer of the samples in Comparative Example 1 and Example 1.

FIG. 3 shows a profile density distribution graph of the samples in Comparative Example 1 and Examples 1 to 4.

FIG. 4 shows a profile density distribution graph of the samples in Example 3 and Example 5.

FIG. 5 shows a heat release rate curve graph of the samples in Comparative Example 1 and Examples 3, 6, and 7.

FIG. 6 shows a total heat release curve graph of the samples in Comparative Example 1 and Examples 3, 6, and 7.

FIG. 7 shows a total smoke production curve graph of the samples in Comparative Example 1 and Examples 3, 6, and 7.

### DETAILED DESCRIPTION OF THE EMBODIMENTS

The present disclosure provides a method for preparing a bamboo with single-sided densification on a bamboo inner layer, including the following steps:
placing the bamboo inner layer of the bamboo in an impregnation solution, and conducting an impregnation treatment to obtain an impregnated bamboo; wherein the impregnation solution comprises one selected from the group consisting of water and a flame retardant solution;
subjecting a resulting bamboo inner layer of the impregnated bamboo to a preheating and softening treatment to obtain a preheated and softened bamboo;
maintaining a temperature for the preheating and softening treatment of the resulting bamboo inner layer, while subjecting the preheated and softened bamboo to pressurization and compression to densify the bamboo to a target thickness, to obtain a compressed bamboo; and
simultaneously subjecting a resulting bamboo inner layer and a bamboo outer layer of the compressed bamboo to a hot pressing and shaping treatment, and subjecting a resulting bamboo to cooling and depressurizing in sequence to obtain the bamboo with single-sided densification on the bamboo inner layer.

In the present disclosure, the bamboo inner layer of the bamboo is placed in an impregnation solution, and an impregnation treatment is conducted to obtain an impregnated bamboo.

In some embodiments of the present disclosure, the bamboo has a thickness of 6 mm to 15 mm. There are no specific limitations on the length and width of the bamboo, but the size of the bamboo should be adapted to the press plate of the hot press, including the bamboo with bamboo joints or only a part between the bamboo joints. In some embodiments of the present disclosure, the bamboo includes one selected from the group consisting of Phyllostachys edulis, Dendrocalamus sinicus, Dendrocalamus latiflorus, Bambusa sinospinosa, and Bambusa pervariabilis. In some embodiments of the present disclosure, the bamboo includes an original bamboo board, and preferably one selected from the group consisting of a nicked flattened bamboo, a non-nicked flattened bamboo, and a rectangular bamboo strip.

In the present disclosure, the impregnation solution includes one selected from the group consisting of water and a flame retardant solution.

In some embodiments of the present disclosure, the flame retardant solution includes diammonium hydrogen phosphate, boric acid, borax, glucose, and water. In some embodiments, the flame retardant solution has a mass concentration of 5-30%, and preferably 10-25%. In some embodiments of the present disclosure, a mass ratio of the diammonium hydrogen phosphate, the boric acid, and the borax is in a range of (2-8):(1-5):(1-5), and preferably 7:(1-2):(1-2). In some embodiments, a molar ratio of the diammonium hydrogen phosphate to the glucose is 1:1. In some embodiments of the present disclosure, the water includes one selected from the group consisting of ionized water, tap water, and pure water. In some embodiments of the present disclosure, the flame retardant solution has a temperature of 30° C. to 60° C.

In some embodiments of the present disclosure, the impregnation treatment is conducted for 0.5 h to 4 h, and preferably 1 h to 4 h. In some embodiments, during the impregnation treatment, a depth of the impregnation is 10-50%, and preferably 20-50%, of a total thickness of the bamboo. The depth of impregnation can be determined by reference to the requirement of the thickness of the compression layer.

In some embodiments of the present disclosure, after the impregnation treatment, a moisture content of the resulting bamboo inner layer of the impregnated bamboo is greater than 15%, and a moisture content of a bamboo outer layer of the impregnated bamboo is in a range of 5-12%.

In the present disclosure, after obtaining an impregnated bamboo, a resulting bamboo inner layer of the impregnated bamboo is subjected to a preheating and softening treatment to obtain a preheated and softened bamboo.

In some embodiments of the present disclosure, the preheating and softening treatment is conducted in a hot press, the preheating and softening treatment is conducted by a process including the following steps: placing the impregnated bamboo in a hot press with a lower press plate not heated and an upper press plate preheated to a temperature of 120° C. to 180° C., and subjecting the impregnated bamboo to the preheating and softening treatment while applying a small pressure of 0.05 MPa to 0.1 MPa.

In some embodiments of the present disclosure, during the preheating and softening treatment, the resulting bamboo inner layer of the bamboo is in contact with the upper press plate, and a bamboo outer layer of the bamboo is in contact with the lower press plate. In some embodiments of the present disclosure, the preheating and softening treatment is conducted for 5 s to 120 s, and preferably 10 s to 100 s. In some embodiments of the present disclosure, during the preheating and softening treatment, the hot press is immediately stopped pressurizing once the bamboo is in contact with the upper press plate, at that moment, the hot press has a pressure of 0.05 MPa to 0.1 MPa, and preferably 0.05 MPa to 0.08 MPa.

In the present disclosure, after obtaining a preheated and softened bamboo, a temperature for the preheating and softening treatment of the resulting bamboo inner layer is maintained, while the preheated and softened bamboo is subjected to pressurization and compression to densify the bamboo to a target thickness, to obtain a compressed bamboo.

In some embodiments of the present disclosure, the pressurization and compression is conducted in a hot press; the pressurization and compression is conducted at a pressure of 2 MPa to 40 MPa, and preferably 5 MPa to 30 MPa; and the pressurization and compression is conducted by progressive pressurization. In some embodiments of the present disclosure, the progressive pressurization is conducted by subjecting the preheated and softened bamboo to pressurization and compression for 1 to 5 cycles, each compression cycle is loaded for 1 s to 3 s, and holding the loading for 5 s to 20 s. In some embodiments of the present disclosure, the loading is conducted with a loading speed of 0.1 mm/s to 2.0 mm/s, and preferably 0.5 mm/s to 1.2 mm/s.

In some embodiments of the present disclosure, the bamboo after the pressurization and compression has a compression ratio of 10 to 50%, and preferably 20 to 40%. In some embodiments of the present disclosure, the bamboo after the pressurization and compression has a thickness of 3 mm to 10 mm, and the thickness is controlled by a metal stopping stick between the hot press plates.

In the present disclosure, after the compressed bamboo is obtained, a resulting bamboo inner layer and a bamboo outer layer of the compressed bamboo are simultaneously subjected to a hot pressing and shaping treatment, and a resulting bamboo is subjected to cooling and depressurizing in sequence to obtain the bamboo with single-sided densification on the bamboo inner layer.

In some embodiments of the present disclosure, the hot pressing and shaping treatment is conducted in a hot press, during the hot pressing and shaping treatment, the bamboo inner layer of the compressed bamboo is heated to a temperature of 120° C. to 180° C., and preferably 130° C. to 160° C. In some embodiments, the bamboo outer layer of the compressed bamboo is heated to a temperature of 130° C. to 180° C., and preferably 130° C. to 160° C. In some embodiments, the hot pressing and shaping treatment is conducted at a pressure of 2 MPa to 40 MPa, and preferably 5 MPa to 30 MPa. In some embodiments of the present disclosure, during the hot pressing and shaping treatment, the pressure is the same as that of pressurization and compression. In some embodiments of the present disclosure, during the hot pressing and shaping treatment, the hot pressing and shaping treatment is conducted under heat preservation and pressure maintenance for 0.5 h to 6 h, and preferably 0.5 h to 5 h.

In the present disclosure, the function of the hot pressing and shaping treatment is as follows: under the action of heat-humidity-force, on the one hand, the water inside the bamboo can be gasified and discharged from the longitudinal conveying channel of the bamboo, and the compression deformation of the bamboo can be temporarily fixed. On the other hand, by prolonging the time of the heat preservation and pressure maintenance, main components of the bamboo will undergo a degradation reaction when heated, which will cause internal molecular movement and release internal residual stress, thereby reducing the deformation recovery and fixing the compression deformation of the bamboo.

In some embodiments of the present disclosure, the cooling and depressurizing is conducted by cooling an upper press plate and a lower press plate of the hot press to a temperature of 30° C. to 50° C. by passing cold water, and then depressurizing. In some embodiments, a cooling rate is controlled by a flow rate of a cold water valve, and the cooling is conducted for 5 min to 50 min.

In the present disclosure, the cooling and depressurizing can prevent defects such as bubbling and cracking caused by the overhigh internal temperature of bamboo.

The present disclosure further provides a bamboo with single-sided densification on the bamboo inner layer prepared by the method described in the above technical solutions, including a compressed layer on the bamboo inner layer, an uncompressed layer on a core, and an uncompressed layer on a bamboo outer layer that are arranged sequentially in a thickness direction.

In some embodiments of the present disclosure, the compressed layer on the bamboo inner layer has a thickness of 2 mm to 4 mm, and the uncompressed layer on the bamboo outer layer has a thickness of 1 mm to 5 mm. In some embodiments of the present disclosure, the compressed layer on the bamboo inner layer has a peak density of 0.8 g/cm³ to 1.5 g/cm³, and the uncompressed layer on the bamboo outer layer has a peak density of 0.8 g/cm³ to 1.2 g/cm³.

The present disclosure further provides use of the bamboo with single-sided densification on the bamboo inner layer described in the above technical solutions in furniture, flooring, cutting boards and building, or interior decoration.

The technical solutions provided by the present disclosure are described below in detail with reference to examples. However, the following description cannot be understood as limiting the scope of the present disclosure.

### Example 1

A flattened bamboo board of Phyllostachys edulis was used as a processing object, with a specification of 150 mm×100 mm×9.3 mm (length×width×thickness) and a density of 0.75 g/cm³.

A specific treatment process was conducted as follows:
(1) A bamboo inner layer of the bamboo sample (with a moisture content of 10%) was impregnated in water for 1 h, and a depth of the impregnation was 20% of a total thickness of the bamboo. A resulting bamboo inner layer after the impregnation treatment had a moisture content of 20%.
(2) A resulting impregnated bamboo was placed in a hot press with a lower press plate not heated and an upper press plate preheated to 140° C. The bamboo inner layer of the impregnated bamboo was placed facing up. 6 mm metal stopping sticks were placed on four sides of press plates. The hot press was closed. The bamboo inner layer of the impregnated bamboo was preheated and softened for 10 s.
(3) A resulting preheated and softened bamboo was subjected to progressive pressurization for one compression cycle, which included loading for 3 s and held the loading for 7 s, with a loading speed of 1.1 mm/s. A resulting bamboo had a compression ratio of 35%.
(4) A temperature of the lower press plate was raised to 140° C., and the lower press plate was subjected to heat preservation and pressure maintenance for 0.5 h, so that the resulting bamboo in the hot press underwent the compression deformation and fixing.
(5) The upper press plate and the lower press plate of the hot press were cooled quickly to 30° C. by passing cold water. The hot press was opened to obtain a bamboo with single-sided densification on a bamboo inner layer.

The bamboo with single-sided densification on the bamboo inner layer obtained in this example was recorded as 140° C.-1-0.5 h.

### Example 2

A flattened bamboo board of Phyllostachys edulis was used as a processing object, with a specification of 150 mm×100 mm×9.3 mm (length×width×thickness) and a density of 0.75 g/cm³.

A specific treatment process was conducted as follows:
(1) A bamboo inner layer of the bamboo sample (with a moisture content of 10%) was impregnated in water for 2 h, and a depth of the impregnation was 30% of a total thickness of the bamboo. A resulting bamboo inner layer after the impregnation treatment had a moisture content of 25%.
(2) A resulting impregnated bamboo was placed in a hot press with a lower press plate not heated and an upper press plate preheated to 140° C. The bamboo inner layer of the impregnated bamboo was placed facing up. 6 mm metal stopping sticks were placed on four sides of press plates. The hot press was closed. The bamboo inner layer of the impregnated bamboo was preheated and softened for 30 s.
(3) A resulting preheated and softened bamboo was subjected to progressive pressurization for two compression cycles, and each compression cycle included loading for 2 s and held the loading for 8 s, with a loading speed of 0.8 mm/s. A resulting bamboo had a compression ratio of 35%.
(4) A temperature of the lower press plate was raised to 140° C., and the lower press plate was subjected to heat preservation and pressure maintenance for 1.5 h, so that the resulting bamboo in the hot press underwent the compression deformation and fixing.
(5) The upper press plate and the lower press plate of the hot press were cooled quickly to 30° C. by passing cold water. The hot press was opened to obtain a bamboo with single-sided densification on a bamboo inner layer.

The bamboo with single-sided densification on the bamboo inner layer obtained in this example was recorded as 140° C.-2-1.5 h.

### Example 3

A flattened bamboo board of Phyllostachys edulis was used as a processing object, with a specification of 150 mm×100 mm×9.3 mm (length×width×thickness) and a density of 0.75 g/cm³.

A specific treatment process was conducted as follows:
(1) A bamboo inner layer of the bamboo sample (with a moisture content of 10%) was impregnated in water for 4 h, and a depth of the impregnation was 40% of a total thickness of the bamboo. A resulting bamboo inner layer after the impregnation treatment had a moisture content of 28%.
(2) A resulting impregnated bamboo was placed in a hot press with a lower press plate not heated and an upper press plate preheated to 140° C. The bamboo inner layer of the impregnated bamboo was placed facing up. 6 mm metal stopping sticks were placed on four sides of press plates. The hot press was closed. The bamboo inner layer of the impregnated bamboo was preheated and softened for 50 s.
(3) A resulting preheated and softened bamboo was subjected to progressive pressurization for three compression cycles, and each compression cycle included loading for 1 s and held the loading for 9 s, with a loading speed of 1.1 mm/s. A resulting bamboo had a compression ratio of 35%.
(4) A temperature of the lower press plate was raised to 140° C., and the lower press plate was subjected to heat preservation and pressure maintenance for 2.5 h, so that the resulting bamboo in the hot press underwent the compression deformation and fixing.
(5) The upper press plate and the lower press plate of the hot press were cooled quickly to 30° C. by passing cold water. The hot press was opened to obtain a bamboo with single-sided densification on a bamboo inner layer.

The bamboo with single-sided densification on the bamboo inner layer obtained in this example was recorded as 140° C.-3-2.5 h.

### Example 4

A flattened bamboo board of Phyllostachys edulis was used as a processing object, with a specification of 150 mm×100 mm×9.3 mm (length×width×thickness) and a density of 0.75 g/cm³.

A specific treatment process was conducted as follows:
(1) A bamboo inner layer of the bamboo sample (with a moisture content of 10%) was impregnated in water for 4 h, and a depth of the impregnation was 50% of a total thickness of the bamboo. A resulting bamboo inner layer after the impregnation treatment had a moisture content of 32%.
(2) A resulting impregnated bamboo was placed in a hot press with a lower press plate not heated and an upper press plate preheated to 140° C. The bamboo inner layer of the impregnated bamboo was placed facing up. 6 mm metal stopping sticks were placed on four sides of press plates. The hot press was closed. The bamboo inner layer of the impregnated bamboo was preheated and softened for 70 s.
(3) A resulting preheated and softened bamboo was subjected to progressive pressurization for four compression cycles, and each compression cycle included loading for 1 s and held the loading for 9 s, with a loading speed of 0.8 mm/s. A resulting bamboo had a compression ratio of 35%.
(4) A temperature of the lower press plate was raised to 140° C., and the lower press plate was subjected to heat preservation and pressure maintenance for 3.5 h, so that the resulting bamboo in the hot press underwent the compression deformation and fixing.
(5) The upper press plate and the lower press plate of the hot press were cooled quickly to 30° C. by passing cold water. The hot press was opened to obtain a bamboo with single-sided densification on a bamboo inner layer.

The bamboo with single-sided densification on the bamboo inner layer obtained in this example was recorded as 140° C.-4-3.5 h.

### Example 5

A flattened bamboo board of Phyllostachys edulis was used as a processing object, with a specification of 150 mm×100 mm×9.3 mm (length×width×thickness) and a density of 0.75 g/cm³.

A specific treatment process was conducted as follows:
(1) A bamboo inner layer of the bamboo sample (with a moisture content of 10%) was impregnated in water for 3 h, and a depth of the impregnation was 40% of a total thickness of the bamboo. A resulting bamboo inner layer after the impregnation treatment had a moisture content of 28%.
(2) A resulting impregnated bamboo was placed in a hot press with a lower press plate not heated and an upper press plate preheated to 160° C. The bamboo inner layer of the impregnated bamboo was placed facing up. 6 mm metal stopping sticks were placed on four sides of press plates. The hot press was closed. The bamboo inner layer of the impregnated bamboo was preheated and softened for 50 s.
(3) A resulting preheated and softened bamboo was subjected to progressive pressurization for three compression cycles, and each compression cycle included loading for 1 s and held the loading for 9 s, with a loading speed of 1.1 mm/s. A resulting bamboo had a compression ratio of 35%.
(4) A temperature of the lower press plate was raised to 160° C., and the lower press plate was subjected to heat preservation and pressure maintenance for 2.5 h, so that the resulting bamboo in the hot press underwent the compression deformation and fixing.
(5) The upper press plate and the lower press plate of the hot press were cooled quickly to 30° C. by passing cold water. The hot press was opened to obtain a bamboo with single-sided densification on a bamboo inner layer.

The bamboo with single-sided densification on the bamboo inner layer obtained in this example was recorded as 160° C.-3-2.5 h.

### Example 6

Example 6 was performed according to Example 3, except that a medium for impregnating and softening the bamboo was a flame retardant solution, and a moisture content of the bamboo inner layer after the impregnation treatment was 26%. Where, a mass ratio of diammonium hydrogen phosphate, boric acid, and borax in the flame retardant solution was 7:1.5:1.5, a molar ratio of glucose to diammonium hydrogen phosphate was 1:1, and a mass fraction of the flame retardant solution was 10%.

The obtained bamboo with single-sided densification on the bamboo inner layer was recorded as FR10%-140° C.

### Example 7

Example 7 was performed according to Example 3, except that a medium for impregnating and softening the bamboo was a flame retardant solution, and a moisture content of the bamboo inner layer after the impregnation treatment was 25%. Where a mass ratio of diammonium hydrogen phosphate, boric acid, and borax in the flame retardant solution was 7:1.5:1.5, a molar ratio of glucose to diammonium hydrogen phosphate was 1:1, and a mass fraction of the flame retardant solution was 20%.

The obtained bamboo with single-sided densification on the bamboo inner layer was recorded as FR20%-140° C.

### Comparative Example 1

A flattened bamboo board of Phyllostachys edulis without any treatment (control material) was subjected to performance tests directly, including micro-morphology (SEM), profile density distribution, surface hardness, and flexural strength.

The flattened bamboo board has a density of 0.75 g/cm³, a specification of 150 mm×100 mm×9.3 mm (length×width×thickness), and an initial moisture content of 10%.

### Comparative Example 2

A flattened bamboo board of Phyllostachys edulis was used as a processing object, with a specification of 150 mm×100 mm×9.3 mm (length×width×thickness) and a density of 0.75 g/cm³.

A specific treatment process was conducted as follows:
(1) A bamboo inner layer of the bamboo sample (with a moisture content of 10%) was impregnated in water for 3 h, and a depth of the impregnation was 40% of a total thickness of the bamboo. A resulting bamboo inner layer after the impregnation treatment had a moisture content of 28%.
(2) A resulting impregnated bamboo was placed in a hot press with an lower press plate not heated and an upper press plate preheated to 140° C. The bamboo inner layer of the impregnated bamboo was placed facing up. 6 mm metal stopping sticks were placed on four sides of press plates. The hot press was closed. The bamboo inner layer of the impregnated bamboo was preheated and softened for 50 s.
(3) A resulting preheated and softened bamboo was subjected to progressive pressurization for three compression cycles, and each compression cycle included loading for 1 s and held the loading for 9 s, with a loading speed of 1.1 mm/s. A resulting bamboo had a compression ratio of 35%.
(4) The upper press plate and the lower press plate of the hot press were cooled quickly to 30° C. by passing cold water. The hot press was opened to obtain a bamboo with single-sided densification on a bamboo inner layer.

The bamboo with single-sided densification on the bamboo inner layer obtained in this comparative example was recorded as 140° C.-3-0 h.

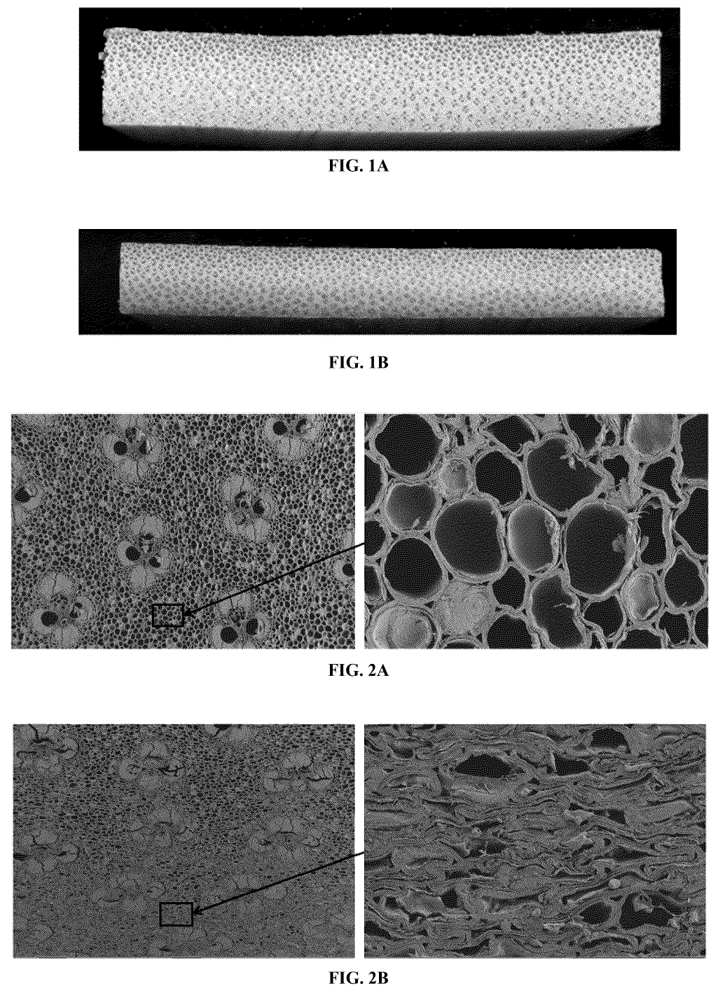

FIG. 1A to FIG. 1B show cross-sectional views of the objects of the samples in Comparative Example 1 and Example 1, in which FIG. 1A shows a control material in Comparative Example 1; FIG. 1B shows the bamboo with single-sided densification on the bamboo inner layer in Example 1. As can be seen from FIG. 1A to FIG. 1B, the tissue structure of the cross section of the bamboo in Comparative Example 1 shows a typical gradient distribution, and the tissue proportion of the vascular bundle decreases from the bamboo outer layer to the bamboo inner layer along the thickness direction of the bamboo. The vascular bundle on the bamboo outer layer is small in shape and has a dense distribution. The vascular bundle on the bamboo inner layer is large in shape and has a sparse distribution. In Example 1, the overall thickness of the bamboo with single-sided densification on the bamboo inner layer becomes thinner, the upper surface and the lower surface are smoother, the cell morphology on the bamboo inner layer changes, and the tissue gap is reduced, but the original tissue structure of the bamboo is still maintained.

FIG. 2A to FIG. 2B show SEM images of the cross-sectional view of the bamboo inner layer of the samples in Comparative Example 1 and Example 1, in which FIG. 2A shows the control material in Comparative Example 1, and FIG. 2B shows the bamboo with single-sided densification on the bamboo inner layer in Example 1. As can be seen from FIG. 2A to FIG. 2B, the morphology of the parenchyma cell of the bamboo with single-sided densification on the bamboo inner layer has changed obviously. From the bamboo outer layer to the bamboo inner layer, the deformation degree of the cell cavity gradually increases, and the volume of the cell cavity and vessel is compressed and reduced. In the process of bamboo inner layer densification, the cell wall of the bamboo inner layer is deformed, due to the transformation of the matrix composed of amorphous cellulose, hemicellulose and lignin from a glassy state to a rubbery state, which realizes the compression strengthening modification of the bamboo inner layer, improves the density and surface hardness of the bamboo inner layer, and enhances its mechanical properties.

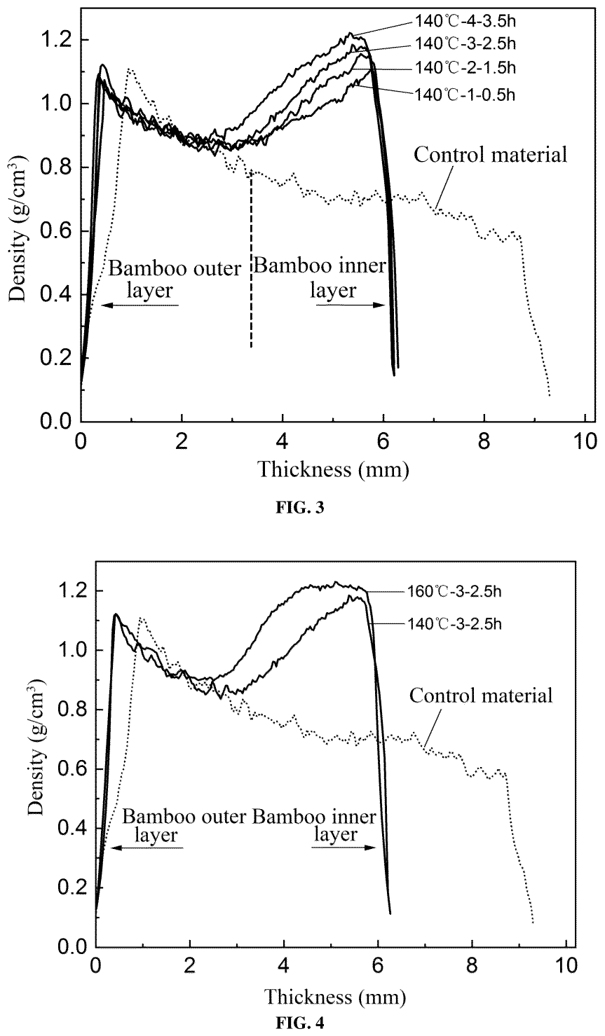

FIG. 3 shows a profile density distribution graph of the samples in Comparative Example 1 and Examples 1 to 4. FIG. 4 shows a profile density distribution graph of the samples in Examples 3 and 5. As can be seen from FIG. 3 to FIG. 4, the density of the control material (the bamboo in Comparative Example 1) gradually decreases from the bamboo outer layer to the bamboo inner layer. The thickness of the bamboo with single-sided densification on the bamboo inner layer becomes thinner, the profile density curve presents a symmetrical structure, and the density of the bamboo inner layer is significantly increased, which is close to the density of the bamboo outer layer, indicating that the bamboo with single-sided densification on the bamboo inner layer is successfully prepared under the conditions of the present disclosure.

The bamboo inner layer is subjected to preheat and progressive pressurization several times by the control program of the press, which could effectively control the peak shape of the density distribution curve of the bamboo with single-sided densification on the bamboo inner layer. Under the condition that the preheating time is short and the pressurization times are few, the density distribution curve of the effective dense layer on the bamboo inner layer presents a narrow and sharp density peak. With the prolongation of preheating time and the increase of pressurization times, the heat transferred from the hot pressing plate to the inner layer on the bamboo inner layer increases, and the softened area on the bamboo inner layer increases, making that the density distribution curve of the effective dense layer on the bamboo inner layer gradually widens, the density gradually increases, and the distance between the peak density and the compressed side surface gradually increases. With the increase of hot-pressing temperature, the heat transferred from the hot pressing plate to the inner layer on the bamboo inner layer increases, and the softening degree of the inner layer on the bamboo inner layer increases, making that the inner layer on the bamboo inner layer is easier to be compacted, thereby increasing the thickness of the total dense layer and increasing the peak density, up to 1.23 g/cm³, which is significantly higher than the density of the bamboo outer layer. The increase of density plays an important role in improving the comprehensive properties of the bamboo.

The physical and mechanical properties of the bamboo with single-sided densification on the bamboo inner layer are characterized, and the results are shown in Table 1. From the results in Table 1, it can be seen that the water absorption deformation recovery rate of the bamboo with single-sided densification on the bamboo inner layer decreases with the increase of the hot pressing temperature or the prolongation of the hot pressing and shaping time. The water absorption deformation recovery rate of the bamboo with single-sided densification on the bamboo inner layer (Comparative Example 2) without hot pressing and shaping treatment is 17.5%. When the hot pressing and shaping temperature is 140° C., the water absorption deformation recovery rate is in a range of 6.6% to 11.2%. Under the condition that the hot pressing and shaping temperature is 160° C., the water absorption deformation recovery rate is reduced to 4.3%, which illustrates that the hot pressing and shaping treatment is an effective method to fix the compression deformation of the bamboo with single-sided densification on the bamboo inner layer.

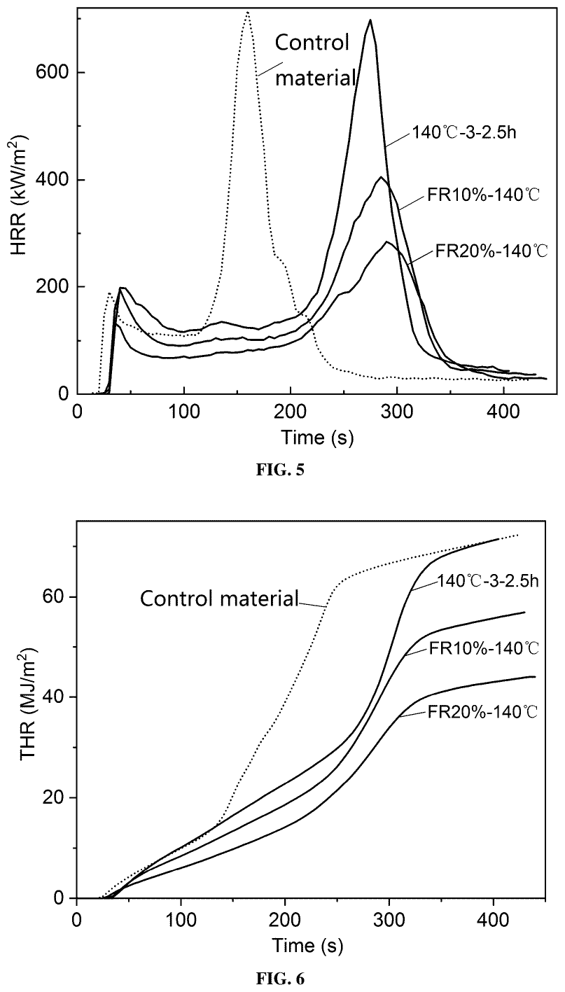

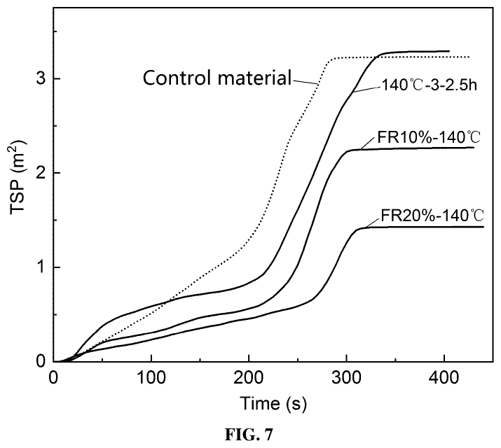

Table 2 and FIGS. 5-7 show the test data of the cone calorimeter of the bamboo with single-sided densification on the bamboo inner layer prepared in Comparative Example 1 and Examples 3, 6, and 7. It can be seen from Table 2 and FIGS. 5-7 that the time to ignition (TTI) of the control material is 19 s, the peak heat release rate (PHRR) is 714.9 kW/m², the total heat release (THR) is up to 73.3 MJ/m², and the total smoke production (TSP) is up to 3.24 m². The single-sided densification on the bamboo inner layer treatment does not significantly reduce the peak heat release rate, total heat release, and total smoke production of the bamboo, but the time to ignition (140° C.-3-2.5 h) is delayed by 4 s, and the occurrence time of the peak heat release rate is delayed by 115 s. The time to ignition of the bamboo treated with the combination of the flame retardant process and single-sided densification on the bamboo inner layer bamboo (FR10%-140° C. and FR20%-140° C.) is further delayed, the peak heat release rate is decreased by 60.2%, the total heat release is decreased by 39.8%, and the total smoke production is decreased by 55.9%. To sum up, the technology of the present disclosure can significantly improve the flame retardant performance of the bamboo under the premise of ensuring the good physical and mechanical properties and dimensional stability of the bamboo with single-sided densification on the bamboo inner layer.

TABLE 1
Test results of physical and mechanical properties

| Example | Example | Example | Example | Example | Example | Example | Example | Comparative | Comparative |
|---|---|---|---|---|---|---|---|---|---|
| group | 1 | 2 | 3 | 4 | 5 | 6 | 7 | Example 1 | Example 2 |
| Peak | 1.11 | 1.16 | 1.18 | 1.22 | 1.23 | 1.17 | 1.19 | Density of | 1.12 |
| density of | | | | | | | | bamboo | |
| compression | | | | | | | | inner layer | |
| layer g/cm³ | | | | | | | | of 0.56-0.78 | |
| Flexural | 248.1 | 264.6 | 273.9 | 276.6 | 279.0 | 270.1 | 266.8 | 124.8 | 257.2 |
| strength | | | | | | | | | |
| MPa | | | | | | | | | |
| Elasticity | 11.5 | 13.6 | 12.5 | 11.7 | 12.8 | 12.2 | 11.5 | 7.7 | 12.6 |
| modulus | | | | | | | | | |
| GPa | | | | | | | | | |
| Surface | 21.6 | 23.2 | 25.3 | 26.8 | 24.5 | 22.9 | 22.5 | 11.3 | 22.9 |
| hardness | | | | | | | | | |
| N/mm² | | | | | | | | | |
| Water | 11.2 | 9.8 | 7.5 | 6.6 | 4.3 | 6.2 | 8.5 | — | 17.5 |
| absorption | | | | | | | | | |
| deformation | | | | | | | | | |
| recovery | | | | | | | | | |
| rate % | | | | | | | | | |

TABLE 2
Test data of the cone calorimeter of the bamboos with single-
sided densification on the bamboo inner layer prepared
in Comparative Example 1 and Examples 3, 6, and 7

| | TTI | | THR | TSP |
|---|---|---|---|---|
| Sample | (s) | PHRR (kW/m²) | (MJ/m²) | (m²) |
| Control material | 19 | 714.9 (peak time: 160 s) | 73.3 | 3.24 |
| 140° C.-3-2.5 h | 23 | 696.4 (peak time: 275 s) | 71.5 | 3.29 |
| FR10%-140° C. | 25 | 404.2 (peak time: 285 s) | 56.8 | 2.27 |
| FR20%-140° C. | 28 | 284.8 (peak time: 290 s) | 44.1 | 1.43 |

It can be seen from the comparison of the above examples and comparative examples that the dimensional stability and mechanical strength of the bamboos with single-sided densification on the bamboo inner layer prepared by the method of the present disclosure are greatly improved, and the density and surface hardness of the bamboo inner layer are improved. Compared with the traditional overall compressed bamboo, when this method is used for the directional compression enhancement of the bamboo inner layer with low density, it has the advantages of high hardness and light weight, and could significantly reduce the volume loss rate of the compressed bamboo. The method is simple and easy to operate, green and environmentally friendly, and has lower energy consumption. By controlling the technological parameters of the preheating and softening treatment, pressurization and compression, and hot pressing and shaping treatment, the control of the thickness and density of the compression layer on the bamboo inner layer can be realized. While maintaining the high density of the bamboo outer layer of natural bamboo, the density, surface hardness and mechanical strength of the bamboo inner layer are directionally improved. In addition, the bamboo is subjected to impregnation and softening treatment with the flame retardant solution as required, so that the flame retardant performance of the bamboo with single-sided densification on the bamboo inner layer is significantly improved under the premise of ensuring good physical and mechanical properties and dimensional stability, which broadens the application fields of original bamboo such as flattened bamboo, and the bamboo is expected to be applied in structural and non-structural fields such as architecture and interior decoration.

The above are merely preferred embodiments of the present disclosure. It should be noted that those skilled in the art may further make several improvements and modifications without departing from the principle of the present disclosure, but such improvements and modifications should be deemed as falling within the scope of the present disclosure.

What is claimed is:

1. A method for preparing a bamboo with single-sided densification on a bamboo inner layer, comprising:
placing the bamboo inner layer of the bamboo in an impregnation solution, and conducting an impregnation treatment to obtain an impregnated bamboo; wherein the impregnation solution comprises one selected from the group consisting of water and a flame retardant solution;
subjecting a resulting bamboo inner layer of the impregnated bamboo to a preheating and softening treatment to obtain a preheated and softened bamboo;
maintaining a temperature for the preheating and softening treatment of the resulting bamboo inner layer, while subjecting the preheated and softened bamboo to pressurization and compression to densify the bamboo to a target thickness, to obtain a compressed bamboo; and
simultaneously subjecting a resulting bamboo inner layer and a bamboo outer layer of the compressed bamboo to a hot pressing and shaping treatment, and subjecting a resulting bamboo to cooling and depressurizing in sequence to obtain the bamboo with single-sided densification on the bamboo inner layer.

2. The method of claim 1, wherein the preheating and softening treatment is conducted by placing the impregnated bamboo in a hot press with a lower press plate not heated and an upper press plate preheated to a temperature of 120° C. to 180° C., and subjecting the impregnated bamboo to the preheating and softening treatment while applying a small pressure of 0.05 MPa to 0.1 MPa; during the preheating and softening treatment, the resulting bamboo inner layer of the impregnated bamboo is in contact with the upper press plate, and a bamboo outer layer of the impregnated bamboo is in contact with the lower press plate; and the preheating and softening treatment is conducted for 5 seconds(s) to 120 seconds(s); and
during the impregnation treatment, a depth of the impregnation is 10-50% of a total thickness of the bamboo; and the impregnation is conducted for 0.5 h to 4 h.

3. The method of claim 1, wherein the bamboo has a thickness of 6 mm to 15 mm;
the bamboo comprises one selected from the group consisting of Phyllostachys edulis, Dendrocalamus sinicus, Dendrocalamus latiflorus, Bambusa sinospinosa, and Bambusa pervariabilis; and
the bamboo comprises one selected from the group consisting of a nicked flattened bamboo, a non-nicked flattened bamboo, and a rectangular bamboo strip.

4. The method of claim 1, wherein the flame retardant solution comprises diammonium hydrogen phosphate, boric acid, borax, glucose, and water;
a mass ratio of the diammonium hydrogen phosphate, the boric acid, and the borax is in a range of (2-8):(1-5):(1-5);
a molar ratio of the diammonium hydrogen phosphate to the glucose is 1:1; and
the flame retardant solution has a mass concentration of 5-30%.

5. The method of claim 1, wherein after the impregnation treatment, a moisture content of the resulting bamboo inner layer of the impregnated bamboo is greater than 15%, and a moisture content of a bamboo outer layer of the impregnated bamboo is in a range of 5-12%.

6. The method of claim 1, wherein the pressurization and compression is conducted in a hot press;
the pressurization and compression is conducted at a pressure of 2 MPa to 40 MPa;
the pressurization and compression is conducted by progressive pressurization; the progressive pressurization is conducted by subjecting the preheated and softened bamboo to pressurization and compression for 1 to 5 cycles, each compression cycle comprises loading for 1 s to 3 s, and holding the loading for 5 s to 20 s, with a loading speed of 0.1 mm/s to 2.0 mm/s; and
during the pressurization and compression, a thickness of the compressed bamboo is controlled by a metal stopping stick between hot press plates, and the compressed bamboo has a compression ratio of 10 to 50%.

7. The method of claim 1, wherein the hot pressing and shaping treatment is conducted in a hot press;
the resulting bamboo inner layer of the compressed bamboo is heated to a temperature of 120° C. to 180° C.;
the bamboo outer layer of the compressed bamboo is heated to a temperature of 130° C. to 180° C.;
the hot pressing and shaping treatment is conducted at a pressure of 2 MPa to 40 MPa; and
the hot pressing and shaping treatment is conducted under heat preservation and pressure maintenance for 0.5 h to 6 h.

8. The method of claim 7, wherein the cooling and depressurizing is conducted by cooling an upper press plate and a lower press plate of the hot press to a temperature of 30° C. to 50° C. by passing cold water, and then depressurizing.

9. A bamboo with single-sided densification on the bamboo inner layer prepared by the method of claim 1, comprising a compressed layer on the bamboo inner layer, an uncompressed layer on a core, and an uncompressed layer on a bamboo outer layer that are arranged sequentially in a thickness direction;
wherein the compressed layer on the bamboo inner layer has a peak density of 0.8 g/cm³ to 1.5 g/cm³, and the uncompressed layer on the bamboo outer layer has a peak density of 0.8 g/cm³ to 1.2 g/cm³.

10. The bamboo with single-sided densification on the bamboo inner layer of claim 9, wherein the preheating and softening treatment is conducted by placing the impregnated bamboo in a hot press with a lower press plate not heated and an upper press plate preheated to a temperature of 120° C. to 180° C., and subjecting the impregnated bamboo to the preheating and softening treatment while applying a small pressure of 0.05 MPa to 0.1 MPa; during the preheating and softening treatment, the resulting bamboo inner layer of the impregnated bamboo is in contact with the upper press plate, and a bamboo outer layer of the impregnated bamboo is in contact with the lower press plate; and the preheating and softening treatment is conducted for 5 seconds(s) to 120 seconds(s); and
during the impregnation treatment, a depth of the impregnation is 10-50% of a total thickness of the bamboo; and the impregnation is conducted for 0.5 h to 4 h.

11. The bamboo with single-sided densification on the bamboo inner layer of claim 9, wherein the bamboo has a thickness of 6 mm to 15 mm;
the bamboo comprises one selected from the group consisting of Phyllostachys edulis, Dendrocalamus sinicus, Dendrocalamus latiflorus, Bambusa sinospinosa, and Bambusa pervariabilis; and
the bamboo comprises one selected from the group consisting of a nicked flattened bamboo, a non-nicked flattened bamboo, and a rectangular bamboo strip.

12. The bamboo with single-sided densification on the bamboo inner layer of claim 9, wherein the flame retardant solution comprises diammonium hydrogen phosphate, boric acid, borax, glucose, and water;
a mass ratio of the diammonium hydrogen phosphate, the boric acid, and the borax is in a range of (2-8):(1-5):(1-5);
a molar ratio of the diammonium hydrogen phosphate to the glucose is 1:1; and
the flame retardant solution has a mass concentration of 5-30%.

13. The bamboo with single-sided densification on the bamboo inner layer of claim 9, wherein after the impregnation treatment, a moisture content of the resulting bamboo inner layer of the impregnated bamboo is greater than 15%, and a moisture content of a bamboo outer layer of the impregnated bamboo is in a range of 5-12%.

14. The bamboo with single-sided densification on the bamboo inner layer of claim 9, wherein the pressurization and compression is conducted in a hot press;
the pressurization and compression is conducted at a pressure of 2 MPa to 40 MPa;
the pressurization and compression is conducted by progressive pressurization; the progressive pressurization is conducted by subjecting the preheated and softened bamboo to pressurization and compression for 1 to 5 cycles, each compression cycle comprises loading for 1 s to 3 s, and holding the loading for 5 s to 20 s, with a loading speed of 0.1 mm/s to 2.0 mm/s; and
during the pressurization and compression, a thickness of the compressed bamboo is controlled by a metal stopping stick between hot press plates, and the compressed bamboo has a compression ratio of 10 to 50%.

15. The bamboo with single-sided densification on the bamboo inner layer of claim 9, wherein the hot pressing and shaping treatment is conducted in a hot press;
the resulting bamboo inner layer of the compressed bamboo is heated to a temperature of 120° C. to 180° C.;
the bamboo outer layer of the compressed bamboo is heated to a temperature of 130° C. to 180° C.;
the hot pressing and shaping treatment is conducted at a pressure of 2 MPa to 40 MPa; and
the hot pressing and shaping treatment is conducted under heat preservation and pressure maintenance for 0.5 h to 6 h.

16. The bamboo with single-sided densification on the bamboo inner layer of claim 9, wherein the cooling and depressurizing is conducted by cooling an upper press plate and a lower press plate of the hot press to a temperature of 30° C. to 50° C. by passing cold water, and then depressurizing.
